(19) United States
(12) Patent Application Publication
(10) Pub. No.: US 2021/0016343 A1
(43) Pub. Date: Jan. 21, 2021

(54) High-efficiency Transmission Free Forging Hydraulic Press and Operation Method thereof

(71) Applicants: Lianhua ZHANG, Yancheng City, Jiangsu (CN); Hui ZHANG, Yancheng City, Jiangsu (CN)

(72) Inventors: Lianhua ZHANG, Yancheng City, Jiangsu (CN); Hui ZHANG, Yancheng City, Jiangsu (CN)

(21) Appl. No.: 16/322,402

(22) PCT Filed: Jun. 14, 2018
(86) PCT No.: PCT/CN2018/091242

§ 371 Date: Jan. 31, 2019

(30) Foreign Application Priority Data
Mar. 26, 2018 (CN) 201810251170.5

(51) Int. Cl. B21J 9/12; F15B 11/072

(52) U.S. Cl. CPC B21J 9/12; F15B 2211/216; F15B 2211/7052; F15B 11/0725

(57) ABSTRACT

Provided is a high-efficiency transmission free forging hydraulic press and an operation method thereof. The high-efficiency transmission free forging hydraulic press includes: a hydraulic cylinder, a hydraulic pump, and a pressurization energy storage apparatus. By providing two pressurization energy storage apparatuses between the hydraulic pump and the hydraulic cylinder of the high-efficiency transmission free forging hydraulic press, under the effect of a control system, the two pressurization energy storage apparatuses can alternately provide isobaric pressure oil or pressure oil having undergone pressurization to the hydraulic cylinder of the free forging hydraulic press, such that when the hydraulic pump operates in a status with a relatively low pressure, the hydraulic cylinder in the free forging hydraulic press can constantly obtain the isobaric pressure oil or the pressurization pressure oil, achieving the object of storage of surplus energy and high-efficiency transmission of the hydraulic press.

### CROSS-REFERENCE TO RELATED APPLICATION

The present disclosure claims the priority to the Chinese patent application with the filing number 201810251170.5 entitled “High-efficiency Transmission Free Forging Hydraulic Press” filed on Mar. 26, 2018 to the Chinese Patent Office, the contents of which are incorporated herein by reference in their entirety.

### TECHNICAL FIELD

The present disclosure relates to the technical field of hydraulic transmission, particularly to a high-efficiency transmission free forging hydraulic press and an operation method thereof.

### BACKGROUND ART

A free forging hydraulic press is usually relatively large in specification, and forgings manufactured are also quite heavy in weight, therefore, multiple high-power hydraulic pumps need to be provided as power sources of a hydraulic system, so as to supply power for hammerhead return stroke ascending, hammerhead idle stroke descending, and hammerhead rolling operation. In practical working conditions, for the hydraulic system of a conventional free forging hydraulic press, a hydraulic pump is in a status of long-term repeated idling to a great extent, and although power configuration thereof meets the requirement of linear speed for forging, electric power resource and electric energy are wasted seriously.

### SUMMARY

In view of problems set forth in the Background Art, an object of the present disclosure includes providing a high-efficiency transmission free forging hydraulic press, which, by providing a pressurization energy storage apparatus in a hydraulic circuit, achieves an objective of low-pressure energy storage and high-pressure output for hydraulic power oil, moreover, the hydraulic press can store energy both in operation and in idleness, thereby realizing storage of surplus energy and high-efficiency transmission of the hydraulic press.

The high-efficiency transmission free forging hydraulic press provided in the present disclosure includes: a hydraulic pump, pressurization energy storage apparatuses, a hydraulic cylinder, a control system, pipelines, and an oil tank, wherein the pressurization energy storage apparatus includes: an energy storage tank and an air pressure tank, a separating unit is provided within the energy storage tank for separating the inside space of the tank into a compartment A and a compartment B, the compartment A and the compartment B are each provided with a piston therein, a piston rod is provided between the piston in the compartment A and the piston in the compartment B, and the piston rod runs through the separating unit and is rigidly connected with the two pistons, such that the two pistons move in synchronization in the energy storage tank; in the compartment A, a rodless compartment is an air chamber, and a rod compartment is an oil chamber, and in the compartment B, a rodless compartment is an oil chamber, and a rod compartment is an air chamber; the air pressure tank communicates with both the air chamber in the compartment A and the air chamber in the compartment B.

The pressurization energy storage apparatus is provided between the hydraulic pump and the hydraulic cylinder, the hydraulic pump, the pressurization energy storage apparatus, and the hydraulic cylinder are connected in series through the pipelines and communicate with each other, pressure oil supplied by the hydraulic pump stores energy in the pressurization energy storage apparatus, the pressurization energy storage apparatus outputs operation pressure oil with different pressures to the hydraulic cylinder; the pressurization energy storage apparatuses are provided in number of two, and the two pressurization energy storage apparatuses are provided in parallel between the hydraulic pump and the hydraulic cylinder; the two pressurization energy storage apparatuses provide alternately the operation pressure oil to the hydraulic cylinder, that is, when a first pressurization energy storage apparatus provides the pressure oil to the hydraulic cylinder, the hydraulic pump supplies oil and stores energy for a second pressurization energy storage apparatus, and when the second pressurization energy storage apparatus provides the pressure oil to the hydraulic cylinder, the hydraulic pump supplies oil and stores energy for the first pressurization energy storage apparatus.

When the high-efficiency transmission free forging hydraulic press is in isobaric operation, the control system controls the hydraulic pump to make the pressure oil stored in both of the oil chambers in the compartment A and the compartment B in the energy storage tank of the second pressurization energy storage apparatus, and controls the oil chambers in the compartment A and the compartment B in the energy storage tank of the first pressurization energy storage apparatus to simultaneously provide isobaric pressure oil to the hydraulic cylinder; alternatively, the control system controls the hydraulic pump to make the pressure oil stored in both of the oil chambers in the compartment A and the compartment B in the energy storage tank of the first pressurization energy storage apparatus, and controls the oil chambers in the compartment A and the compartment B in the energy storage tank of the second pressurization energy storage apparatus to simultaneously provide the isobaric operation pressure oil to the hydraulic cylinder.

When the high-efficiency transmission free forging hydraulic press is in pressurization operation, the control system controls the hydraulic pump to make the pressure oil stored in both of the oil chambers in the compartment A and the compartment B in the energy storage tank of the second pressurization energy storage apparatus, and controls the oil chamber in the compartment A in the energy storage tank of the first pressurization energy storage apparatus to be in communication with the oil tank so as to release the pressure oil, the piston in the compartment A transmits a gas pressure in the air chamber in the compartment A to the piston in the compartment B through the piston rod, and then the gas pressure is transmitted from the piston in the compartment B to the pressure oil in the oil chamber in the compartment B, such that the oil chamber in the compartment B supplies pressurization operation pressure oil to the hydraulic cylinder; alternatively, the control system controls the hydraulic pump to make the pressure oil stored in both of the oil chambers in the compartment A and the compartment B in the energy storage tank of the first pressurization energy storage apparatus, and controls the oil chamber in the compartment A in the energy storage tank of the second pressurization energy storage apparatus to be in communication with the oil tank so as to release the pressure oil, the piston in the compartment A transmits a gas pressure in the air chamber in the compartment A to the piston in the compartment B through the piston rod, and then the gas pressure is transmitted from the piston in the compartment B to the pressure oil in the oil chamber in the compartment B, such that the oil chamber in the compartment B supplies pressurization operation pressure oil to the hydraulic cylinder.

Further, the hydraulic pump communicates with the oil chambers in each of the energy storage tanks respectively through the pipelines, and each of the pipelines is provided with a first electromagnetic valve configured to control on and off of the pipeline.

Further, the oil chambers in each of the energy storage tanks communicate with the hydraulic cylinder through the pipelines, and each of the pipelines is provided with a second electromagnetic valve configured to control on and off of the pipeline.

Further, the oil chamber in the compartment A in each of the energy storage tanks communicates with the oil chamber in the compartment B through the pipeline, and the pipeline is provided with a third electromagnetic valve configured to control on and off of the pipeline.

Further, the oil chamber in the compartment A in each of the energy storage tanks communicates with the oil tank through the pipeline, and the pipeline is provided with a fourth electromagnetic valve configured to control on and off of the pipeline.

Further, each of the energy storage tanks is provided with a displacement sensor, and the displacement sensor is configured to detect a movement distance of the pistons.

Further, the pipelines are used for communication between the hydraulic pump and the oil chamber in the compartment B in each of the energy storage tanks, between the oil chamber in the compartment B in each of the energy storage tanks and the hydraulic cylinder, between the oil chamber in the compartment A and the oil chamber in the compartment B in each of the energy storage tanks, as well as between the oil chamber in the compartment A in each of the energy storage tanks and the oil tank, and the pipeline between the hydraulic pump and the oil chamber in the compartment B is provided with a first electromagnetic valve, the pipeline between the oil chamber in the compartment B and the hydraulic cylinder is provided with a second electromagnetic valve, the pipeline between the oil chamber in the compartment A and the oil chamber in the compartment B is provided with a third electromagnetic valve, and the pipeline between the oil chamber in the compartment A and the oil tank is provided with a fourth electromagnetic valve, wherein the pipeline provided with the third electromagnetic valve has one end intersecting the pipeline provided with the first electromagnetic valve, and the other end intersecting the pipeline provided with the fourth electromagnetic valve, and hydraulic oil flowing out through the hydraulic pump is capable of passing through the first electromagnetic valve, the third electromagnetic valve, and the fourth electromagnetic valve successively, to return back to the oil tank.

Further, the first electromagnetic valve, the second electromagnetic valve, the third electromagnetic valve, and the fourth electromagnetic valve are all the two-position two-way valves.

Further, the pipeline between the hydraulic pump and the pressurization energy storage apparatus is further provided with an overflow valve.

Further, the separating unit includes a separating plate arranged perpendicular to an axis of the energy storage tank, and the separating plate is provided with a hole that is configured for allowing the piston rod to pass therethrough.

Further, a sealing structure is provided between the piston rod and the hole, configured to prevent oil liquid in the oil chamber in the compartment A from flowing to the air chamber in the compartment B.

Further, the hole is located at a center of the separating plate.

Object of the present disclosure further includes providing an operation method for a high-efficiency transmission free forging hydraulic press, implemented by the above-described high-efficiency transmission free forging hydraulic press, including a method of enabling isobaric operation of the hydraulic cylinder and a method of enabling pressurization operation of the hydraulic cylinder.

Further, when the hydraulic cylinder is in isobaric operation: the oil chamber in the energy storage tank of the first pressurization energy storage apparatus firstly supplies isobaric operation pressure oil to the hydraulic cylinder, when information that the piston in the energy storage tank runs to a setting position is detected by a displacement sensor in the energy storage tank of the first pressurization energy storage apparatus, it is instructed that an electromagnetic valve on the pipeline for communication between the oil chamber in the energy storage tank of the first pressurization energy storage apparatus and the hydraulic cylinder is turned off, an electromagnetic valve on the pipeline for communication between the oil chamber in the energy storage tank of the second pressurization energy storage apparatus and the hydraulic cylinder is turned on, an electromagnetic valve on the pipeline for communication between the hydraulic pump and the oil chamber in the energy storage tank of the first pressurization energy storage apparatus is turned on, an electromagnetic valve on the pipeline for communication between the hydraulic pump and the oil chamber in the energy storage tank of the second pressurization energy storage apparatus is turned off, and electromagnetic valves on the pipelines for communication between the oil chambers in the compartments A in the energy storage tanks of the two pressurization energy storage apparatuses and the oil tank are both turned off, at this time, the oil chambers in the compartment A and the compartment B in the energy storage tank of the first pressurization energy storage apparatus simultaneously store the pressure oil, and the oil chambers in the compartment A and the compartment B in the energy storage tank of the second pressurization energy storage apparatus simultaneously provide isobaric operation pressure oil to the hydraulic cylinder;

when information that the piston in the energy storage tank runs to a setting position is detected by a displacement sensor in the energy storage tank of the second pressurization energy storage apparatus, it is instructed that an electromagnetic valve on the pipeline for communication between the oil chamber in the energy storage tank of the second pressurization energy storage apparatus and the hydraulic cylinder is turned off, an electromagnetic valve on the pipeline for communication between the oil chamber in the energy storage tank of the first pressurization energy storage apparatus and the hydraulic cylinder is turned on, an electromagnetic valve on the pipeline for communication between the hydraulic pump and the oil chamber in the energy storage tank of the second pressurization energy storage apparatus is turned on, an electromagnetic valve on the pipeline for communication between the hydraulic pump and the oil chamber in the energy storage tank of the first pressurization energy storage apparatus is turned off, and electromagnetic valves on the pipelines for communication between the oil chambers in the compartments A in the energy storage tanks of the two pressurization energy storage apparatuses and the oil tank are both turned off, at this time, the oil chambers in the compartment A and the compartment B in the energy storage tank of the second pressurization energy storage apparatus simultaneously store the pressure oil, and the oil chambers in the compartment A and the compartment B in the energy storage tank of the first pressurization energy storage apparatus simultaneously provide isobaric operation pressure oil to the hydraulic cylinder.

Further, when the hydraulic cylinder is in pressurization operation: an electromagnetic valve on the pipeline for communication between the oil chamber in the compartment A in the energy storage tank of the first pressurization energy storage apparatus and the oil tank is turned on, an electromagnetic valve on the pipeline for communication between the oil chamber in the compartment A and the oil chamber in the compartment B is turned off; an electromagnetic valve on the pipeline for communication between the oil chamber in the compartment A in the energy storage tank of the second pressurization energy storage apparatus and the oil tank is turned off, an electromagnetic valve on the pipeline for communication between the oil chamber in the compartment A and the oil chamber in the compartment B is turned on; an electromagnetic valve on the pipeline for communication between the oil chamber in the compartment B in the energy storage tank of the first pressurization energy storage apparatus and the hydraulic cylinder is turned on, and an electromagnetic valve on the pipeline for communication between the oil chamber in the compartment B in the energy storage tank of the second pressurization energy storage apparatus and the hydraulic cylinder is turned off, the oil chambers in the compartment A and the compartment B in the energy storage tank of the second pressurization energy storage apparatus simultaneously store the pressure oil, and the oil chamber in the compartment B in the energy storage tank of the first pressurization energy storage apparatus supplies pressurization operation pressure oil to the hydraulic cylinder;

when information that the piston runs to a setting position is detected by a displacement sensor in the energy storage tank of the first pressurization energy storage apparatus, it is instructed that an electromagnetic valve on the pipeline for communication between the oil chamber in the compartment A in the energy storage tank of the second pressurization energy storage apparatus and the oil tank is turned on, an electromagnetic valve on the pipeline for communication between the oil chamber in the compartment A and the oil chamber in the compartment B is turned off; an electromagnetic valve on the pipeline for communication between the oil chamber in the compartment A in the energy storage tank of the first pressurization energy storage apparatus and the oil tank is turned off, an electromagnetic valve on the pipeline for communication between the oil chamber in the compartment A and the oil chamber in the compartment B is turned on; an electromagnetic valve on the pipeline for communication between the oil chamber in the compartment B in the energy storage tank of the second pressurization energy storage apparatus and the hydraulic cylinder is turned on, and an electromagnetic valve on the pipeline for communication between the oil chamber in the compartment B in the energy storage tank of the first pressurization energy storage apparatus and the hydraulic cylinder is turned off, the oil chambers in the compartment A and the compartment B in the energy storage tank of the first pressurization energy storage apparatus simultaneously store the pressure oil, and the oil chamber in the compartment B in the energy storage tank of the second pressurization energy storage apparatus supplies pressurization operation pressure oil to the hydraulic cylinder.

By providing two pressurization energy storage apparatuses between the hydraulic pump and the hydraulic cylinder of the high-efficiency transmission free forging hydraulic press, under the effect of the control system, the two pressurization energy storage apparatuses can alternately provide the isobaric pressure oil and the pressurization pressure oil to the hydraulic cylinder of the free forging hydraulic press, such that when the hydraulic pump operates in a status with a relatively low pressure, the hydraulic cylinder can also obtain hydraulic power oil with a relatively high pressure, and continuous oil supply to the hydraulic cylinder is realized, thus achieving the object of storage of surplus energy and high-efficiency transmission of the hydraulic press.

The high-efficiency transmission free forging hydraulic press has remarkable advantages of having less resource configuration, being simple in structure, having high transmission efficiency, and being energy-saving and consumption-reducing.

### BRIEF DESCRIPTION OF DRAWINGS

FIG. 1 is a structural schematic diagram of a hydraulic circuit of a high-efficiency transmission free forging hydraulic press provided in an embodiment of the present disclosure;

FIG. 2 is a diagram of the hydraulic circuit of the high-efficiency transmission free forging hydraulic press provided in an embodiment of the present disclosure, when a hydraulic cylinder is in a status of isobaric operation;

FIG. 3 is another diagram of the hydraulic circuit of the high-efficiency transmission free forging hydraulic press provided in an embodiment of the present disclosure, when the hydraulic cylinder is in the status of isobaric operation;

FIG. 4 is a diagram of a hydraulic circuit of the high-efficiency transmission free forging hydraulic press provided in an embodiment of the present disclosure, when the hydraulic cylinder is in a status of pressurization operation; and

FIG. 5 is another diagram of the hydraulic circuit of the high-efficiency transmission free forging hydraulic press provided in an embodiment of the present disclosure, when the hydraulic cylinder is in the status of pressurization operation.

### REFERENCE SIGNS

1—hydraulic pump; 2, 2′—first electromagnetic valve; 3, 3′—third electromagnetic valve; 4, 4′—fourth electromagnetic valve; 5, 5′—displacement sensor; 6, 6′—energy storage tank; 7, 7′—air pressure tank; 8, 8′—second electromagnetic valve; 9—hydraulic cylinder; 10—overflow valve; 11—oil tank; 12—hydraulic cylinder control valve.

### DETAILED DESCRIPTION OF EMBODIMENTS

In order to make objects, technical solutions, and advantages of the present disclosure clearer, the technical solutions in the present disclosure will be described below clearly and completely in combination with accompanying drawings. Apparently, the embodiments described are only some of the embodiments in the present disclosure, rather than all of the embodiments. Based on the embodiments in the present disclosure, all of other embodiments obtained by a person ordinarily skilled in the art without paying inventive efforts shall fall within the scope of protection of the present disclosure.

In the description of the present disclosure, it should be indicated that orientational or positional relationships indicated by terms such as “upper” and “lower” are based on orientational or positional relationships as shown in the accompanying drawings, merely for facilitating describing the present disclosure and simplifying the description, rather than indicating or implying that the indicated apparatuses or elements have to be in the specific orientation or configured and operated in a specific orientation, therefore, they should not be construed as limiting the present disclosure. Besides, terms “first”, “second”, “third”, and “forth” are merely for descriptive purpose, but should not be construed as indicating or implying relative importance.

In the description of the present disclosure, it should be indicated that unless otherwise explicitly specified and defined, terms “connect” and “join” should be construed in a broad sense. For example, it may be fixed connection, detachable connection, or integral connection; it may be mechanical connection, and also may be electrical connection; it may be direct joining, indirect joining through an intermediate medium, or inner communication between two elements. For a person ordinarily skilled in the art, specific meanings of the above-mentioned terms in the present disclosure can be understood according to specific circumstances.

The present disclosure is further explained and described below in combination with the accompanying drawings.

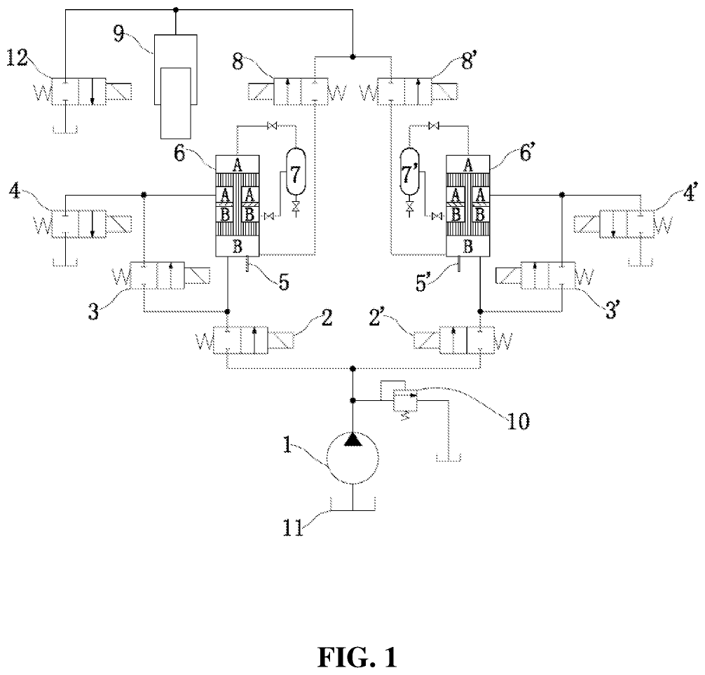

The present embodiment provides a high-efficiency transmission free forging hydraulic press, including a hydraulic pump, pressurization energy storage apparatuses, a hydraulic cylinder, a control system, pipelines, and an oil tank 11. As shown in FIG. 1, therein, the pressurization energy storage apparatuses include: an energy storage tank 6 and an energy storage tank 6′, and an air pressure tank 7 and an air pressure tank 7′, with a separating unit being provided within each of the energy storage tank 6 and the energy storage tank 6′ for separating the inside space of each tank into a compartment A and a compartment B. The compartment A and the compartment B are each provided with a piston therein, moreover, a piston rod is provided between the pistons, and the piston rod runs through the separating unit to rigidly connect the two pistons, such that the two pistons in each of the energy storage tank 6 and the energy storage tank 6′ can move in synchronization in the compartments thereof.

Specifically, in the present embodiment, in each energy storage tank, in the compartment A, a rodless compartment is an air chamber, and a rod compartment is an oil chamber, and in the compartment B, a rodless compartment is an oil chamber, and a rod compartment is an air chamber. The high-efficiency transmission free forging hydraulic press includes two pressurization energy storage apparatuses, with the energy storage tank 6 and the energy storage tank 6′, and the air pressure tank 7 and the air pressure tank 7′ being provided in the two pressurization energy storage apparatuses respectively, and the two pressurization energy storage apparatuses are provided in parallel between the hydraulic pump 1 and the hydraulic cylinder 9 of the hydraulic press, and the air chambers in the energy storage tank 6 and in the energy storage tank 6′ communicate with the air pressure tank 7 and the air pressure tank 7′ respectively through pipelines.

Continuing to refer to FIG. 1, the hydraulic pump 1 communicates with the oil chambers in the energy storage tank 6 and the energy storage tank 6′ respectively through pipelines, and a first electromagnetic valve 2 and a first electromagnetic valve 2′ are respectively provided on the pipelines; the oil chambers in the energy storage tank 6 and the energy storage tank 6′ communicate with the hydraulic cylinder 9 through pipelines, and a second electromagnetic valve 8 and a second electromagnetic valve 8′ are respectively provided on the pipelines; a pipeline for communication is provided between the oil chamber in the compartment A and the oil chamber in the compartment B in each of the energy storage tanks 6 and 6′, and a third electromagnetic valve 3 and a third electromagnetic valve 3′ are provided on the communication pipelines; a pipeline for communication is provided between the oil chamber in the compartment A in each of the energy storage tank 6 and the energy storage tank 6′ and the oil tank 11, and a fourth electromagnetic valve 4 and a fourth electromagnetic valve 4′ are provided on the communication pipelines; the energy storage tank 6 is provided with a displacement sensor 5 therein, the energy storage tank 6′ is provided with a displacement sensor 5′ therein, moreover, the pipeline provided with the third electromagnetic valve 3 has one end intersecting the pipeline provided with the first electromagnetic valve 2, and the other end intersecting the pipeline provided with the fourth electromagnetic valve 4, and hydraulic oil flowing out through the hydraulic pump 1 can pass through the first electromagnetic valve 2, the third electromagnetic valve 3, and the fourth electromagnetic valve 4 sequentially, to return back to the oil tank 11; similarly, in the other pressurization energy storage apparatus, the pipeline provided with the third electromagnetic valve 3′ has one end intersecting the pipeline provided with the first electromagnetic valve 2′, and the other end intersecting the pipeline provided with the fourth electromagnetic valve 4′, and hydraulic oil flowing out through the hydraulic pump 1 can pass through the first electromagnetic valve 2′, the third electromagnetic valve 3′, and the fourth electromagnetic valve 4′ sequentially, to return back to the oil tank 11.

Continuing to refer to FIG. 1, in the present embodiment, the first electromagnetic valve 2, the first electromagnetic valve 2′, the second electromagnetic valve 8, the second electromagnetic valve 8′, the third electromagnetic valve 3, the third electromagnetic valve 3′, the fourth electromagnetic valve 4, and the fourth electromagnetic valve 4′ are all two-position two-way valves.

Continuing to refer to FIG. 1, in the present embodiment, an overflow valve 10 is further provided on the pipeline between the hydraulic pump 1 and the pressurization energy storage apparatus.

When a pressure in the hydraulic circuit is too high, the overflow valve 10 is turned on, and oil liquid overflows back to the oil tank 11. Such provision realizes safety protection to the hydraulic circuit, effectively maintains the stable pressure in the hydraulic circuit, and ensures operation reliability of the hydraulic circuit.

Continuing to refer to FIG. 1, specifically, in the present embodiment, the overflow valve 10 is located between the first electromagnetic valve 2 and the hydraulic pump 1, meanwhile, the overflow valve 10 is also located between the first electromagnetic valve 2′ and the hydraulic pump 1.

Continuing to refer to FIG. 1, illustration is made by taking the separating unit in one pressurization energy storage apparatus as an example. In the present embodiment, the separating unit includes a separating plate arranged perpendicular to an axis of the energy storage tank 6, wherein the separating plate is provided with a hole that is configured for allowing the piston rod to pass therethrough. The separating unit in the other pressurization energy storage apparatus is the same as the above-described separating unit in structure and mode of provision, and will not be repeated redundantly herein.

Such mode of provision of the separating unit is simple in structure, and greatly reduces the manufacturing cost of the high-efficiency transmission free forging hydraulic press in the present embodiment.

It should be indicated that in the present embodiment, the separating plate can be provided in a mode of provision of being completely perpendicular to the axis of the energy storage tank 6, and also can be approximately perpendicular to the axis of the energy storage tank 6, as long as a separation of an inner compartment body of the energy storage tank 6 can be realized through such mode of provision of the separating plate.

In the present embodiment, a material of the separating plate may be stainless steel, and a surface of the separating plate further may be subjected to anti-corrosion treatment.

Continuing to refer to FIG. 1, in the present embodiment, the hole may be located at a center of the separating plate. Such provision guarantees symmetry between the oil chamber in the compartment A and the air chamber in the compartment B, thus ensuring the stability of the piston movement to a certain extent.

Besides, in the present embodiment, a sealing structure may be further provided between the piston rod and the hole, for preventing the oil liquid in the oil chamber in the compartment A from flowing into the air chamber in the compartment B. Such provision effectively reduces occurrence of phenomena of leakage, and ensures operation reliability and control accuracy of the hydraulic system.

Specifically, the sealing structure may include an annular groove opened into an inner surface of the hole and a sealing ring provided in the annular groove, wherein an inner surface of the sealing ring closely abuts against an outer circumferential surface of the piston rod. Such provision is simple in structure and has a relatively low cost. In the present embodiment, in order to ensure sealing reliability, the sealing structure may be provided in multiple. Continuing to refer to FIG. 1, in the present embodiment, the high-efficiency transmission free forging hydraulic press further can include a hydraulic cylinder control valve 12. Under the control effect of the hydraulic cylinder control valve, hammerhead return stroke ascending, hammerhead idle stroke descending, and hammerhead rolling operation of the hydraulic press are realized.

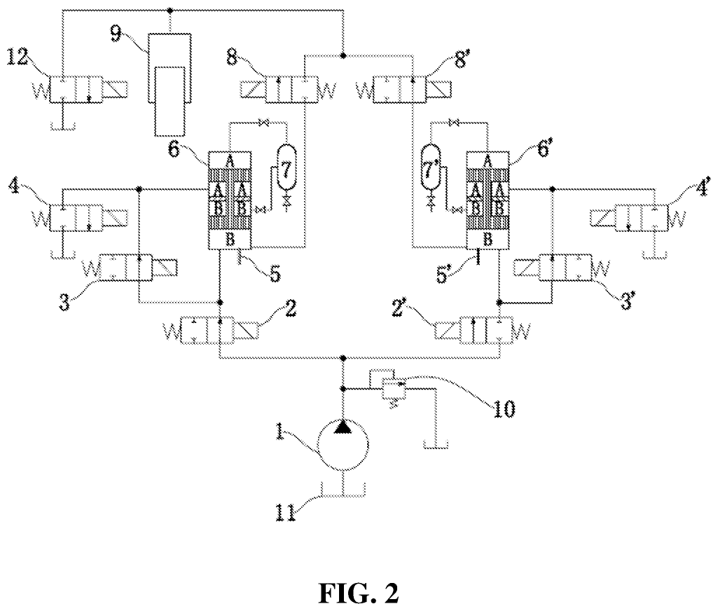

An isobaric operation process of the high-efficiency transmission free forging hydraulic press (the pressure of the hydraulic pump supplying the pressure oil to the energy storage tank is equal to the pressure of the pressure oil output from the energy storage tank to the hydraulic cylinder) is as follows: as shown in FIG. 2, the energy storage tank 6 in the first pressurization energy storage apparatus firstly supplies pressure oil to the hydraulic cylinder 9, when information that the piston in the energy storage tank 6 runs to a setting position is detected by the displacement sensor 5 in the energy storage tank 6, it is instructed that the second electromagnetic valve 8 on the pipeline for communication between the oil chamber in the energy storage tank 6 and the hydraulic cylinder 9 is turned off, the second electromagnetic valve 8′ on the pipeline for communication between the oil chamber in the energy storage tank 6′ in the second pressurization energy storage apparatus and the hydraulic cylinder 9 is turned on, the first electromagnetic valve 2 and the third electromagnetic valve 3 on the pipeline for communication between the hydraulic pump 1 and the energy storage tank 6 are turned on, the first electromagnetic valve 2′ on the pipeline for communication between the hydraulic pump 1 and the oil chamber in the energy storage tank 6′ is turned off, and the third electromagnetic valve 3′ is turned on, and the fourth electromagnetic valve 4 on the pipeline for communication between the oil chamber in the compartment A in the energy storage tank 6 and the oil tank 11, and the fourth electromagnetic valve 4′ on the pipeline for communication between the oil chamber in the compartment A in the energy storage tank 6′ and the oil tank 11 are turned off. At this time, the oil chambers in the compartment A and the compartment B in the energy storage tank 6 in the first pressurization energy storage apparatus simultaneously store the pressure oil, and the oil chambers in the compartment A and the compartment B in the energy storage tank 6′ of the second pressurization energy storage apparatus simultaneously provide isobaric operation pressure oil to the hydraulic cylinder 9.

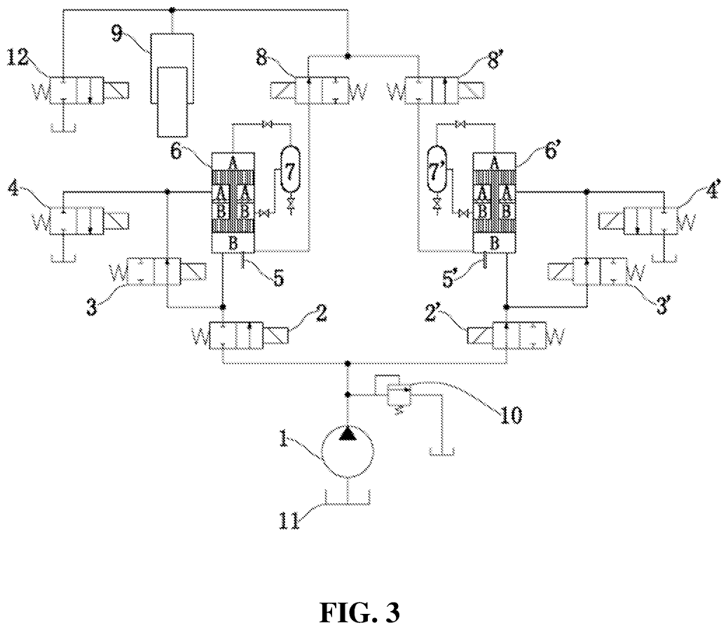

As shown in FIG. 3, when information that the piston in the energy storage tank 6′ runs to a setting position is detected by the displacement sensor 5′ in the second pressurization energy storage apparatus, it is instructed that the second electromagnetic valve 8′ on the pipeline for communication between the oil chamber in the energy storage tank 6′ and the hydraulic cylinder 9 is turned off, the second electromagnetic valve 8 on the pipeline for communication between the oil chamber in the energy storage tank 6 and the hydraulic cylinder 9 is turned on, the first electromagnetic valve 2′ and the third electromagnetic valve 3′ on the pipeline for communication between the hydraulic pump 1 and the energy storage tank 6′ are turned on, the first electromagnetic valve 2 on the pipeline for communication between the hydraulic pump 1 and the oil chamber in the energy storage tank 6 is turned off, and the third electromagnetic valve 3 is turned on, and the fourth electromagnetic valve 4 on the pipeline for communication between the oil chamber in the compartment A in the energy storage tank 6 and the oil tank 11, and the fourth electromagnetic valve 4′ on the pipeline for communication between the oil chamber in the compartment A in the energy storage tank 6′ and the oil tank 11 are turned off. At this time, the oil chambers in the compartment A and the compartment B in the energy storage tank 6′ in the second pressurization energy storage apparatus simultaneously store the pressure oil, and the oil chambers in the compartment A and the compartment B in the energy storage tank 6 of the first pressurization energy storage apparatus simultaneously provide isobaric operation pressure oil to the hydraulic cylinder 9.

When information that the piston in the energy storage tank 6 runs to a setting position is detected by the displacement sensor 5 in the first pressurization energy storage apparatus, a next operation cycle starts.

By means of the alternate compensation operation of the two pressurization energy storage apparatuses, the high-efficiency transmission free forging hydraulic press achieves objects of alternate oil storage of both the energy storage tank 6 and the energy storage tank 6′ through the hydraulic pump 1, and of continuous supply of the isobaric operation pressure oil to the hydraulic cylinder 9 through the energy storage tank 6 and the energy storage tank 6′.

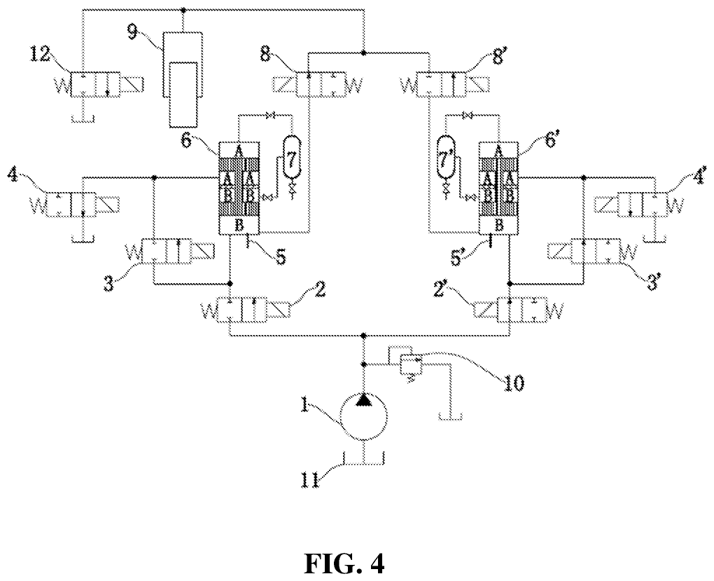

A pressurization operation process of the high-efficiency transmission free forging hydraulic press (the pressure of the air chamber in the compartment A is transmitted to the piston in the compartment B through the piston rod, and the pressure on the oil chamber in the compartment B is increased, which increases the pressure of the supplied oil from the oil chamber in the compartment B to the hydraulic cylinder) is as follows: as shown in FIG. 4, the fourth electromagnetic valve 4 on the pipeline for communication between the oil chamber in the compartment A in the energy storage tank 6 of the first pressurization energy storage apparatus and the oil tank 11 is turned on, the third electromagnetic valve 3 on the pipeline for communication between the oil chamber in the compartment A and the oil chamber in the compartment B is turned off, moreover, the first electromagnetic valve 2 on the pipeline for communication between the hydraulic pump 1 and the oil chamber in the energy storage tank 6 is turned off, the fourth electromagnetic valve 4′ on the pipeline for communication between the oil chamber in the compartment A in the energy storage tank 6′ of the second pressurization energy storage apparatus and the oil tank 11 is turned off, the third electromagnetic valve 3′ on the pipeline for communication between the oil chamber in the compartment A and the oil chamber in the compartment B is turned on, moreover, the first electromagnetic valve 2′ on the pipeline for communication between the hydraulic pump 1 and the oil chamber in the energy storage tank 6′ is turned on, the second electromagnetic valve 8 on the pipeline for communication between the oil chamber in the compartment B in the energy storage tank 6 of the pressurization energy storage apparatus and the hydraulic cylinder 9 is turned on, and the second electromagnetic valve 8′ on the pipeline for communication between the oil chamber in the compartment B in the energy storage tank 6′ of the pressurization energy storage apparatus and the hydraulic cylinder 9 is turned off. At this time, the oil chambers in the compartment A and the compartment B in the energy storage tank 6′ of the pressurization energy storage apparatus simultaneously store the pressure oil, and the oil chamber in the compartment B in the energy storage tank 6 of the pressurization energy storage apparatus supplies pressurization operation pressure oil to the hydraulic cylinder 9.

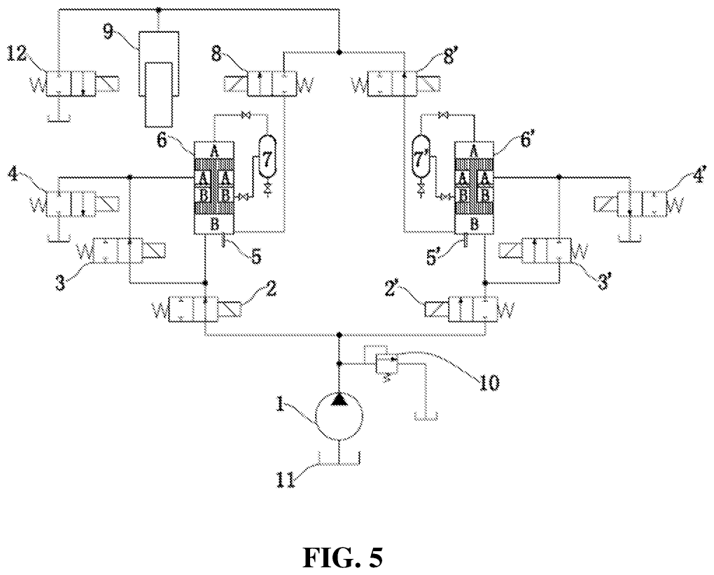

As shown in FIG. 5, when information that the piston runs to a setting position is detected by the displacement sensor 5 in the energy storage tank 6 of the first pressurization energy storage apparatus, it is instructed that the fourth electromagnetic valve 4′ on the pipeline for communication between the oil chamber in the compartment A in the energy storage tank 6′ of the second pressurization energy storage apparatus and the oil tank 11 is turned on, the third electromagnetic valve 3′ on the pipeline for communication between the oil chamber in the compartment A and the oil chamber in the compartment B is turned off, moreover, the first electromagnetic valve 2′ on the pipeline for communication between the hydraulic pump 1 and the oil chamber in the energy storage tank 6′ is turned off, the fourth electromagnetic valve 4 on the pipeline for communication between the oil chamber in the compartment A in the energy storage tank 6 of the first pressurization energy storage apparatus and the oil tank 11 is turned off, the third electromagnetic valve 3 on the pipeline for communication between the oil chamber in the compartment A and the oil chamber in the compartment B is turned on, moreover, the first electromagnetic valve 2 on the pipeline for communication between the hydraulic pump 1 and the oil chamber in the energy storage tank 6 is turned on, the second electromagnetic valve 8′ on the pipeline for communication between the oil chamber in the compartment B in the energy storage tank 6′ of the second pressurization energy storage apparatus and the hydraulic cylinder 9 is turned on, and the second electromagnetic valve 8 on the pipeline for communication between the oil chamber in the compartment B in the energy storage tank 6 of the first pressurization energy storage apparatus and the hydraulic cylinder 9 is turned off. At this time, the oil chambers in the compartment A and the compartment B in the energy storage tank 6 of the first pressurization energy storage apparatus simultaneously store the pressure oil, and the oil chamber in the compartment B in the energy storage tank 6′ of the second pressurization energy storage apparatus supplies pressurization operation pressure oil to the hydraulic cylinder.

When information that the piston runs to a setting position is detected by the displacement sensor 5′ in the energy storage tank 6′ of the second pressurization energy storage apparatus, a next operation cycle starts.

By means of the alternate compensation operation of the two pressurization energy storage apparatuses, the high-efficiency transmission free forging hydraulic press achieves objects of alternate oil storage of both the energy storage tank 6 and the energy storage tank 6′ through the hydraulic pump 1, and of continuous supply of pressurization operation pressure oil to the hydraulic cylinder 9 through the energy storage tank 6 and the energy storage tank 6′.

The present embodiment further provides an operation method for a high-efficiency transmission free forging hydraulic press, which is implemented by the above-described high-efficiency transmission free forging hydraulic press, and includes a method of enabling isobaric operation of the hydraulic cylinder 9 and a method of enabling pressurization operation of the hydraulic cylinder 9. The method of enabling isobaric operation of the hydraulic cylinder 9 and the method of enabling pressurization operation of the hydraulic cylinder 9 thereof have been described in detail in the isobaric operation process and the atmospheric-pressure operation process of the above-described high-efficiency transmission free forging hydraulic press, and will not be repeated redundantly herein.

The above-mentioned is detailed description for the specific embodiments of the present disclosure, but the contents are merely for the preferred embodiments of the creation of the present disclosure, and should not be considered as limiting the implementation scope of the creation of the present disclosure. Any equivalent alterations, improvements, etc. made according to the application scope of the creation of the present disclosure should fall within the scope covered by the present patent.

### INDUSTRIAL APPLICABILITY

With the high-efficiency transmission free forging hydraulic press and the operation method thereof provided in the present disclosure, the isobaric pressure oil or the pressurization pressure oil can be supplied alternately to the hydraulic cylinder of the hydraulic press, such that when the hydraulic pump operates in a status with a relatively low pressure, the hydraulic cylinder can constantly obtain the isobaric pressure oil or the pressurization pressure oil, realizing storage of surplus energy and high-efficiency transmission of the hydraulic press. Moreover, the high-efficiency transmission free forging hydraulic press is simple in structure, and consumes relatively less energy.

1. A high-efficiency transmission free forging hydraulic press, comprising: a hydraulic pump, pressurization energy storage apparatuses, a hydraulic cylinder, a control system, pipelines, and an oil tank, wherein the pressurization energy storage apparatus comprises: an energy storage tank and an air pressure tank, a separating unit is provided within the energy storage tank for separating an inside space of the tank into a compartment A and a compartment B, the compartment A and the compartment B are each provided with a piston therein, a piston rod is provided between the piston in the compartment A and the piston in the compartment B, and the piston rod runs through the separating unit and is rigidly connected with the two pistons, such that the two pistons move in synchronization in the energy storage tank; in the compartment A, a rodless compartment is an air chamber, and a rod compartment is an oil chamber, and in the compartment B, a rodless compartment is an oil chamber, and a rod compartment is an air chamber; the air pressure tank communicates with both the air chamber in the compartment A and the air chamber in the compartment B,
wherein the pressurization energy storage apparatus is provided between the hydraulic pump and the hydraulic cylinder, the hydraulic pump, the pressurization energy storage apparatus, and the hydraulic cylinder are connected in series through the pipelines and communicate with each other, pressure oil supplied by the hydraulic pump stores energy in the pressurization energy storage apparatus, the pressurization energy storage apparatus outputs operation pressure oil with different pressures to the hydraulic cylinder; the pressurization energy storage apparatuses are provided in number of two, and the two pressurization energy storage apparatuses are provided in parallel between the hydraulic pump and the hydraulic cylinder; the two pressurization energy storage apparatuses provide alternately the operation pressure oil to the hydraulic cylinder, that is, when a first pressurization energy storage apparatus provides the pressure oil to the hydraulic cylinder, the hydraulic pump supplies oil and stores energy for a second pressurization energy storage apparatus, and when the second pressurization energy storage apparatus provides the pressure oil to the hydraulic cylinder, the hydraulic pump supplies oil and stores energy for the first pressurization energy storage apparatus;
when the high-efficiency transmission free forging hydraulic press is in isobaric operation, the control system controls the hydraulic pump to make the pressure oil stored in both of the oil chambers in the compartment A and the compartment B in the energy storage tank of the second pressurization energy storage apparatus, and controls the oil chambers in the compartment A and the compartment B in the energy storage tank of the first pressurization energy storage apparatus to simultaneously provide isobaric pressure oil to the hydraulic cylinder; alternatively, the control system controls the hydraulic pump to make the pressure oil stored in both of the oil chambers in the compartment A and the compartment B in the energy storage tank of the first pressurization energy storage apparatus, and controls the oil chambers in the compartment A and the compartment B in the energy storage tank of the second pressurization energy storage apparatus to simultaneously provide isobaric operation pressure oil to the hydraulic cylinder;
when the high-efficiency transmission free forging hydraulic press is in pressurization operation, the control system controls the hydraulic pump to make the pressure oil stored in both of the oil chambers in the compartment A and the compartment B in the energy storage tank of the second pressurization energy storage apparatus, and controls the oil chamber in the compartment A in the energy storage tank of the first pressurization energy storage apparatus to be in communication with the oil tank so as to release the pressure oil, the piston in the compartment A transmits a gas pressure in the air chamber in the compartment A to the piston in the compartment B through the piston rod, and then the gas pressure is transmitted from the piston in the compartment B to the pressure oil in the oil chamber in the compartment B, such that the oil chamber in the compartment B supplies pressurization operation pressure oil to the hydraulic cylinder; alternatively, the control system controls the hydraulic pump to make the pressure oil stored in both of the oil chambers in the compartment A and the compartment B in the energy storage tank of the first pressurization energy storage apparatus, and controls the oil chamber in the compartment A in the energy storage tank of the second pressurization energy storage apparatus to be in communication with the oil tank so as to release the pressure oil, the piston in the compartment A transmits a gas pressure in the air chamber in the compartment A to the piston in the compartment B through the piston rod, and then the gas pressure is transmitted from the piston in the compartment B to the pressure oil in the oil chamber in the compartment B, such that the oil chamber in the compartment B supplies the pressurization operation pressure oil to the hydraulic cylinder.

2. The high-efficiency transmission free forging hydraulic press according to claim 1, wherein the hydraulic pump communicates with the oil chambers in each of the energy storage tanks respectively through the pipelines, and each of the pipelines is provided with a first electromagnetic valve configured to control on and off of the pipeline.

3. The high-efficiency transmission free forging hydraulic press according to claim 1, wherein the oil chambers in each of the energy storage tanks communicate with the hydraulic cylinder through the pipelines, and each of the pipelines is provided with a second electromagnetic valve configured to control on and off of the pipeline.

4. The high-efficiency transmission free forging hydraulic press according to claim 1, wherein the oil chamber in the compartment A in each of the energy storage tanks communicates with the oil chamber in the compartment B through a pipeline, and the pipeline is provided with a third electromagnetic valve configured to control on and off of the pipeline.

5. The high-efficiency transmission free forging hydraulic press according to claim 1, wherein the oil chamber in the compartment A in each of the energy storage tanks communicates with the oil tank through a pipeline, and the pipeline is provided with a fourth electromagnetic valve configured to control on and off of the pipeline.

6. The high-efficiency transmission free forging hydraulic press according to claim 1, wherein each of the energy storage tanks is provided with a displacement sensor, and the displacement sensor is configured to detect a movement distance of the pistons.

7. The high-efficiency transmission free forging hydraulic press according to claim 1, wherein the pipelines are used for communication between the hydraulic pump and the oil chamber in the compartment B in each of the energy storage tanks, between the oil chamber in the compartment B in each of the energy storage tanks and the hydraulic cylinder, between the oil chamber in the compartment A and the oil chamber in the compartment B in each of the energy storage tanks, as well as between the oil chamber in the compartment A in each of the energy storage tanks and the oil tank, and a pipeline between the hydraulic pump and the oil chamber in the compartment B is provided with a first electromagnetic valve, a pipeline between the oil chamber in the compartment B and the hydraulic cylinder is provided with a second electromagnetic valve, a pipeline between the oil chamber in the compartment A and the oil chamber in the compartment B is provided with a third electromagnetic valve, and a pipeline between the oil chamber in the compartment A and the oil tank is provided with a fourth electromagnetic valve, wherein the pipeline provided with the third electromagnetic valve has one end intersecting the pipeline provided with the first electromagnetic valve, and the other end intersecting the pipeline provided with the fourth electromagnetic valve, and hydraulic oil flowing out through the hydraulic pump is capable of passing through the first electromagnetic valve, the third electromagnetic valve, and the fourth electromagnetic valve sequentially, to return back to the oil tank.

8. The high-efficiency transmission free forging hydraulic press according to claim 7, wherein the first electromagnetic valve, the second electromagnetic valve, the third electromagnetic valve, and the fourth electromagnetic valve are all two-position two-way valves.

9. The high-efficiency transmission free forging hydraulic press according to claim 7, wherein the pipeline between the hydraulic pump and the pressurization energy storage apparatus is further provided with an overflow valve.

10. The high-efficiency transmission free forging hydraulic press according to claim 1, wherein the separating unit comprises a separating plate arranged perpendicular to an axis of the energy storage tank, and the separating plate is provided with a hole that is configured for allowing the piston rod to pass therethrough.

11. The high-efficiency transmission free forging hydraulic press according to claim 10, wherein a sealing structure is provided between the piston rod and the hole, configured to prevent oil liquid in the oil chamber in the compartment A from flowing to the air chamber in the compartment B.

12. The high-efficiency transmission free forging hydraulic press according to claim 10, wherein the hole is located at a center of the separating plate.

13. An operation method of a high-efficiency transmission free forging hydraulic press implemented by the high-efficiency transmission free forging hydraulic press according to claim 1, comprising a method of enabling isobaric operation of the hydraulic cylinder and a method of enabling pressurization operation of the hydraulic cylinder.

14. The operation method of a high-efficiency transmission free forging hydraulic press according to claim 13, wherein when the hydraulic cylinder is in isobaric operation: the oil chamber in the energy storage tank of the first pressurization energy storage apparatus firstly supplies the isobaric operation pressure oil to the hydraulic cylinder, when information that the piston in the energy storage tank runs to a setting position is detected by a displacement sensor in the energy storage tank of the first pressurization energy storage apparatus, it is instructed that an electromagnetic valve on the pipeline for communication between the oil chamber in the energy storage tank of the first pressurization energy storage apparatus and the hydraulic cylinder is turned off, an electromagnetic valve on the pipeline for communication between the oil chamber in the energy storage tank of the second pressurization energy storage apparatus and the hydraulic cylinder is turned on, an electromagnetic valve on the pipeline for communication between the hydraulic pump and the oil chamber in the energy storage tank of the first pressurization energy storage apparatus is turned on, an electromagnetic valve on the pipeline for communication between the hydraulic pump and the oil chamber in the energy storage tank of the second pressurization energy storage apparatus is turned off, and electromagnetic valves on the pipelines for communication between the oil chambers in the compartments A in the energy storage tanks of the two pressurization energy storage apparatuses and the oil tank are both turned off, at this time, the oil chambers in the compartment A and the compartment B in the energy storage tank of the first pressurization energy storage apparatus simultaneously store the pressure oil, and the oil chambers in the compartment A and the compartment B in the energy storage tank of the second pressurization energy storage apparatus simultaneously provide the isobaric operation pressure oil to the hydraulic cylinder;
when information that the piston in the energy storage tank runs to a setting position is detected by a displacement sensor in the energy storage tank of the second pressurization energy storage apparatus, it is instructed that an electromagnetic valve on the pipeline for communication between the oil chamber in the energy storage tank of the second pressurization energy storage apparatus and the hydraulic cylinder is turned off, an electromagnetic valve on the pipeline for communication between the oil chamber in the energy storage tank of the first pressurization energy storage apparatus and the hydraulic cylinder is turned on, an electromagnetic valve on the pipeline for communication between the hydraulic pump and the oil chamber in the energy storage tank of the second pressurization energy storage apparatus is turned on, an electromagnetic valve on the pipeline for communication between the hydraulic pump and the oil chamber in the energy storage tank of the first pressurization energy storage apparatus is turned off, and electromagnetic valves on the pipelines for communication between the oil chambers in the compartments A in the energy storage tanks of the two pressurization energy storage apparatuses and the oil tank are both turned off, at this time, the oil chambers in the compartment A and the compartment B in the energy storage tank of the second pressurization energy storage apparatus simultaneously store the pressure oil, and the oil chambers in the compartment A and the compartment B in the energy storage tank of the first pressurization energy storage apparatus simultaneously provide the isobaric operation pressure oil to the hydraulic cylinder.

15. The operation method of a high-efficiency transmission free forging hydraulic press according to claim 13, wherein when the hydraulic cylinder is in pressurization operation: an electromagnetic valve on the pipeline for communication between the oil chamber in the compartment A in the energy storage tank of the first pressurization energy storage apparatus and the oil tank is turned on, an electromagnetic valve on the pipeline for communication between the oil chamber in the compartment A and the oil chamber in the compartment B is turned off; an electromagnetic valve on the pipeline for communication between the oil chamber in the compartment A in the energy storage tank of the second pressurization energy storage apparatus and the oil tank is turned off, an electromagnetic valve on the pipeline for communication between the oil chamber in the compartment A and the oil chamber in the compartment B is turned on; an electromagnetic valve on the pipeline for communication between the oil chamber in the compartment B in the energy storage tank of the first pressurization energy storage apparatus and the hydraulic cylinder is turned on, and an electromagnetic valve on the pipeline for communication between the oil chamber in the compartment B in the energy storage tank of the second pressurization energy storage apparatus and the hydraulic cylinder is turned off, the oil chambers in the compartment A and the compartment B in the energy storage tank of the second pressurization energy storage apparatus simultaneously store the pressure oil, and the oil chamber in the compartment B in the energy storage tank of the first pressurization energy storage apparatus supplies the pressurization operation pressure oil to the hydraulic cylinder;
when information that the piston runs to a setting position is detected by a displacement sensor in the energy storage tank of the first pressurization energy storage apparatus, it is instructed that an electromagnetic valve on the pipeline for communication between the oil chamber in the compartment A in the energy storage tank of the second pressurization energy storage apparatus and the oil tank is turned on, an electromagnetic valve on the pipeline for communication between the oil chamber in the compartment A and the oil chamber in the compartment B is turned off; an electromagnetic valve on the pipeline for communication between the oil chamber in the compartment A in the energy storage tank of the first pressurization energy storage apparatus and the oil tank is turned off, an electromagnetic valve on the pipeline for communication between the oil chamber in the compartment A and the oil chamber in the compartment B is turned on; an electromagnetic valve on the pipeline for communication between the oil chamber in the compartment B in the energy storage tank of the second pressurization energy storage apparatus and the hydraulic cylinder is turned on, and an electromagnetic valve on the pipeline for communication between the oil chamber in the compartment B in the energy storage tank of the first pressurization energy storage apparatus and the hydraulic cylinder is turned off, the oil chambers in the compartment A and the compartment B in the energy storage tank of the first pressurization energy storage apparatus simultaneously store the pressure oil, and the oil chamber in the compartment B in the energy storage tank of the second pressurization energy storage apparatus supplies the pressurization operation pressure oil to the hydraulic cylinder.

16. The operation method of a high-efficiency transmission free forging hydraulic press according to claim 13, wherein the hydraulic pump communicates with the oil chambers in each of the energy storage tanks respectively through the pipelines, and each of the pipelines is provided with a first electromagnetic valve configured to control on and off of the pipeline.

17. The operation method of a high-efficiency transmission free forging hydraulic press according to claim 13, wherein the oil chambers in each of the energy storage tanks communicate with the hydraulic cylinder through the pipelines, and each of the pipelines is provided with a second electromagnetic valve configured to control on and off of the pipeline.

18. The operation method of a high-efficiency transmission free forging hydraulic press according to claim 13, wherein the oil chamber in the compartment A in each of the energy storage tanks communicates with the oil chamber in the compartment B through a pipeline, and the pipeline is provided with a third electromagnetic valve configured to control on and off of the pipeline.

19. The operation method of a high-efficiency transmission free forging hydraulic press according to claim 13, wherein the oil chamber in the compartment A in each of the energy storage tanks communicates with the oil tank through a pipeline, and the pipeline is provided with a fourth electromagnetic valve configured to control on and off of the pipeline.

20. The operation method of a high-efficiency transmission free forging hydraulic press according to claim 13, wherein each of the energy storage tanks is provided with a displacement sensor, and the displacement sensor is configured to detect a movement distance of the pistons.
